(19) United States
(12) Patent Application Publication
(10) Pub. No.: US 2025/0337068 A1
(43) Pub. Date: Oct. 30, 2025

(54) ELECTRONIC SYSTEM WITH SEALING ELEMENT

(71) Applicant: Valeo Systemes Thermiques, Le Mesnil Saint-Denis (FR)

(72) Inventors: Lionel Robillon, Le Mesnil-Saint-Denis (FR); Mohamed Ibrahimi, Le Mesnil-Saint-Denis (FR); Fabienne Tourneux, Le Mesnil-Saint-Denis (FR); Juan-Carlos Batista, Le Mesnil-Saint-Denis (FR)

(73) Assignee: Valeo Systemes Thermiques, Le Mesnil Saint-Denis (FR)

(21) Appl. No.: 18/572,471

(22) PCT Filed: Jun. 14, 2022
(86) PCT No.: PCT/EP2022/066221

§ 371 Date: Jun. 6, 2024

(30) Foreign Application Priority Data
Jun. 22, 2021 (FR) 2106643

(51) Int. Cl. H01M 50/209; H01M 10/6556; H01M 10/6567; H01M 50/244; H01M 50/249

(52) U.S. Cl. CPC H01M 50/209; H01M 10/6556; H01M 10/6567; H01M 50/244; H01M 50/249; H01M 2220/20

(57) ABSTRACT

An electronic system includes electrical and/or electronic components and a temperature regulating device that includes a case. The case is configured to accommodate the electrical and/or electronic components. The case includes a bottom wall and side walls opposite each other in pairs defining an inner recess capable of receiving the components positioned side-by-side in a longitudinal direction of the case. The case also includes at least one temperature-regulating fluid supply element and at least one temperature-regulating fluid discharge element. The electronic system includes a sealing element that is configured to be arranged both between the components and the walls of the case and in each gap formed between two neighboring components.

The present invention lies in the field of temperature-regulating devices for electrical or electronic components, and it relates more particularly to a temperature-regulating device for an electronic system with electrical and/or electronic components that can heat up when they are operating.

The electronic systems to which the present invention can relate may consist equally of computer servers and electrical energy storage systems for motor vehicles, and more particularly for hybrid or electric vehicles.

The electric drives of such vehicles involve electronic systems that can take the form of batteries, which undergo successive electrical charging and discharging phases, and which must be temperature-regulated in order to protect the components that they comprise. When these electronic systems heat up, for example during rapid charging, it is thus important to be able to cool them quickly and efficiently, so that they remain efficient.

Temperature-regulating devices can thus be associated with these batteries, to modify a temperature of an electric battery, either during starting of the vehicle in cold weather, by increasing its temperature for example, or when traveling, or during an operation for recharging the battery, by decreasing the temperature of this electric battery, which tends to heat up when it is being used.

In general, such temperature-regulating devices for electric batteries use heat exchangers. The different battery cells of an electrical storage system can in particular be cooled by means of a cold plate, inside which a temperature-regulating fluid flows, the plate being in contact with the battery cells to be cooled. It has been found that such heat exchangers can lead to uneven cooling of the electric batteries of the same electrical storage system, thus giving rise to a decrease in the overall performance of the electrical storage system. These temperature-regulating devices also have high thermal resistance, because of the thicknesses of material present between the temperature-regulating fluid and the battery cells.

For the purpose of providing a response to these different problems, devices are known for regulating the temperature of the electric battery elements of electric or hybrid motor vehicles comprising a hermetically sealed housing in which the battery elements of the electrical energy storage system are immersed in a dielectric temperature-regulating fluid. This therefore ensures an exchange of heat between the battery elements and the dielectric fluid, with a dielectric fluid tank being situated outside the housing, and connected to said housing by means of a pump, in order to allow the flow of the dielectric fluid and the replacement of this dielectric fluid inside the housing. As a result, the dielectric fluid, which is set in motion and cooled before it returns to the housing, can also flow inside the housing around the electrical storage cells.

The components of the electronic systems are thus at least partially immersed in the temperature-regulating fluid, which has the capacity to recover the heat energy released by the electronic systems, and thus contributes to the cooling thereof. The more the electronic system is filled with temperature-regulating fluid, the better the thermal effect on the electrical and/or electronic components of the electronic system. However, in this context of optimizing the temperature regulation of the electronic system, it should be ensured that the electrical connection elements of the components of this electronic system are safe and operational, that is, it should be ensured that these electrical connection elements are not immersed in the temperature-regulating fluid.

The present invention falls within this context by proposing an electronic system comprising electrical and/or electronic components and a temperature-regulating device comprising a case configured to accommodate the electrical and/or electronic components, this case having a bottom wall and side walls opposite each other in pairs defining an inner recess capable of receiving the electrical and/or electronic components positioned side-by-side in a longitudinal direction of the case, this case comprising at least one temperature-regulating fluid supply element and at least one temperature-regulating fluid discharge element, the electronic system being characterized in that it comprises a sealing element, configured to be arranged both between the electrical and/or electronic components and the walls of the case, and in each gap formed between two neighboring electrical and/or electronic components.

This electronic system is therefore made up of electrical and/or electronic components and a temperature-regulating device comprising a case in which these components are accommodated in order to be immersed in temperature-regulating fluid. In addition, the electronic system is particular in that the temperature-regulating device has a sealing element integrally forming an obstacle to the discharge of the temperature-regulating fluid between the components and the walls of the case, and an obstacle to the discharge of this fluid between the components. The purpose of this sealing element is to ensure that the portions of the electrical and/or electronic components that bear the connection elements are not in contact with the temperature-regulating fluid. The sealing element according to the invention is made up of a single piece, which is configured to be positioned both between the electrical and/or electronic components and the side walls of the case, and between the electrical and/or electronic components themselves. It will thus be understood that the single sealing element surrounds each electrical and/or electronic component, and also surrounds the assembly formed by the juxtaposition of all of the electrical and/or electronic components.

According to one feature of the invention, the electrical and/or electronic components extend mainly in a direction perpendicular to the bottom wall, the sealing element being positioned in contact with the electrical and/or electronic components, in the vicinity of the vertical end of the electrical and/or electronic components opposite the bottom wall.

This positioning of the sealing element makes it possible to optimize the quantity of temperature-regulating fluid within the case of the temperature-regulating device, so as to increase the efficiency of the heat exchange performed by the fluid, while ensuring the sealing of the vertical end of the electrical and/or electronic components opposite the bottom wall, this vertical end being the end that bears the connection elements of the electrical and/or electronic components, which thus remain accessible.

According to one feature of the invention, the sealing element is made up of an edge following the shape of the faces of the walls of the case defining the inner recess, and transverse ribs positioned equidistant from each other, these transverse ribs being substantially perpendicular to the longitudinal direction of the case.

According to one embodiment of the invention, the edge of the sealing element and the transverse ribs extend mainly in the same plane.

The sealing element can thus be designed so that it is substantially flat, so that the edge and the transverse ribs are positioned in the same plane, and by way of example, a plane that comprises a longitudinal axis. Such a sealing element has a small footprint, and in particular a small vertical footprint, which allows optimum flow of the temperature-regulating fluid around the electrical and/or electronic components.

According to an alternative embodiment, the edge of the sealing element is extended by a flank extending substantially perpendicular to the plane in which this edge mainly extends, the transverse ribs extending from this flank. In this context, it will be noted that the transverse ribs do not extend in line with the edge, but offset, in particular vertically, with respect to this edge.

According to one particular embodiment, the sealing element comprises a rigid body and an elastically deformable part added to this rigid body.

The sealing element thus comprises a rigid body, which acts as a rigid skeleton to which a part made from an elastically deformable material is added, being overmolded for example. The rigid body ensures the stability and solidity of the sealing element, while the elastically deformable part guarantees optimum sealing, this part being able to deform to follow the shape of the electrical and/or electronic components that it surrounds. The rigid body can, without limiting the invention, contribute to defining the edge of the sealing element and each of the transverse ribs, or can be provided solely on the edge of the sealing element.

Advantageously, the sealing element rests on a shoulder formed in the faces of the walls of the case defining the inner recess, this shoulder being present on each of the faces.

This shoulder ensures that the sealing element is held inside the case of the temperature-regulating device.

According to one feature of the invention, the sealing element is in position in the case by interaction between the edge of the sealing element and the shoulder of the case. As mentioned above, at least the edge comprises a rigid body, which ensures a stable position of the sealing element resting on the shoulder.

Advantageously, the case has a lid, this lid having an opening giving access to the connection elements of the electrical and/or electronic components positioned in the inner recess, the peripheral region of the inner recess being covered by the lid.

The peripheral region of the inner recess is defined as the region located in the vicinity of the side walls of the case. It should be noted that the shoulder formed on the side walls and against which the edge of the sealing element rests is arranged in this peripheral region so that the lid covers the edge of the sealing element when it rests against the case.

According to one optional feature of the invention, the faces of the walls of the case defining the inner recess that are perpendicular to the longitudinal direction of the case comprise notches extending from a vertical end edge of said walls that is opposite the bottom wall, substantially perpendicular to the bottom wall.

The notches can extend from the shoulder of the faces of the walls of the case defining the inner recess.

According to one optional feature of the invention, elastic return means, intended to hold the electrical and/or electronic components with respect to each other, are positioned in the notches, so that they are interposed between the corresponding wall of the case and one of the electrical and/or electronic components.

According to one optional feature of the invention, the electrical and/or electronic components are separated from at least one electrical and/or electronic component by a separating member.

This separating member acts as a spacer, which keeps two elements apart. The separating member can for example be a corrugated sheet that defines channels for the passage of fluid along each of the electrical and/or electronic components positioned on either side of this separating member.

According to one feature of the invention, the separating member is configured to let the temperature-regulating fluid pass between two electrical and/or electronic components.

For example, the electrical and/or electronic components are separated by a distance of between 0.2 and 1 mm by the separating member. This distance can in particular be adjusted as a function of the viscosity of the temperature-regulating fluid.

According to one embodiment of the invention, the case comprises a base and a lid, the base consisting of the bottom wall and the side walls, this base being integrally formed.

The base of the case then forms a one-piece assembly such that the bottom wall cannot be separated from the side walls without damaging one or the other. This one-piece assembly can in particular be obtained by additive manufacturing, for example by 3D printing.

According to one alternative embodiment of the invention, the case comprises a base and a lid, the base consisting of the bottom wall and the side walls, this base being formed by a first element comprising the bottom wall and two opposite side walls, the other two side walls being added and fastened to the first element.

More particularly, the first element of the base can be formed by the bottom wall and the transversely opposite side walls that bear the supply and discharge elements, the other two side walls being added to the first element to subsequently close the inner recess. This embodiment requires several manufacturing operations; the base can for example be formed by pressing, and then the other side walls are fastened to this base by brazing.

According to one feature of the invention, the case is made from a material selected for its thermal insulation properties.

This material selected for its thermal insulation properties is particularly a plastic material. Even more particularly, the plastic material can be organosheet.

According to one alternative feature of the invention, at least the bottom wall and the walls bearing the supply element and the discharge element are made from metal. More particularly, this metal can be aluminum.

The invention further relates to a method for obtaining an electronic system as described above, comprising a step of positioning an assembly comprising at least the electrical and/or electronic components in the inner recess defined by the bottom wall and the side walls of the case and a step during which the sealing element is arranged both between the electrical and/or electronic components and the walls of the case, and in each gap formed between two neighboring electrical and/or electronic components.

It will be understood that electrical and/or electronic components alone can form this assembly comprising at least the electrical and/or electronic components. Conversely, other elements can be added to these electrical and/or electronic components to form this assembly and be involved in this positioning step.

According to one feature of the invention, the assembly comprising at least the electrical and/or electronic components comprises at least one separating member positioned between two neighboring electrical and/or electronic components.

According to another feature of the invention, the method comprises a step of holding in position the electrical and/or electronic components, between the positioning step and the step during which the sealing element is arranged, this holding step consisting of positioning elastic return means between two opposite side walls and the assembly formed by at least the electrical and/or electronic components.

Further features, details and advantages of the invention will become more clearly apparent from reading the following description, and from studying exemplary embodiments given by way of non-limiting illustration, with reference to the appended drawings, in which:

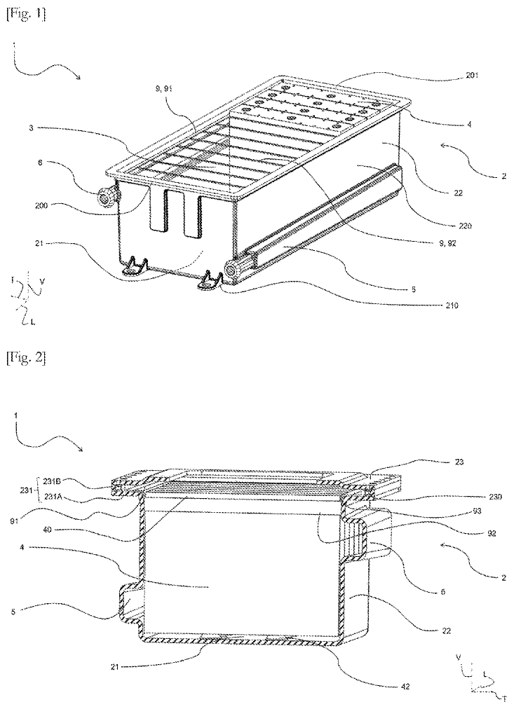

FIG. 1 schematically illustrates a perspective view of an electronic system according to the invention comprising a temperature-regulating device and electrical and/or electronic components, some of these components having been removed to show a sealing element of the electronic system;

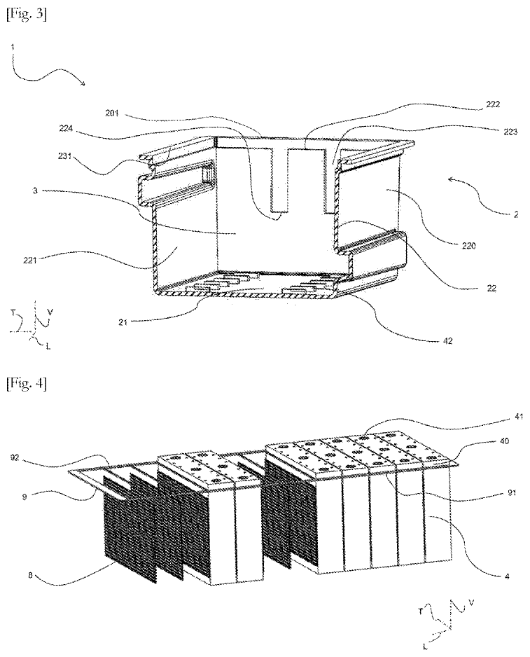

FIG. 2 schematically illustrates the electronic system in FIG. 1, seen in a vertical and transverse section plane;

FIG. 3 is a similar view to FIG. 2, in which all of the electrical and/or electronic components have been removed to show the case in which these components are able to be housed;

FIG. 4 schematically illustrates a perspective view of an electronic system the case of which has been removed to show the interaction of the electrical and/or electronic components with the sealing element and separating members intended to be arranged between these electrical and/or electronic components;

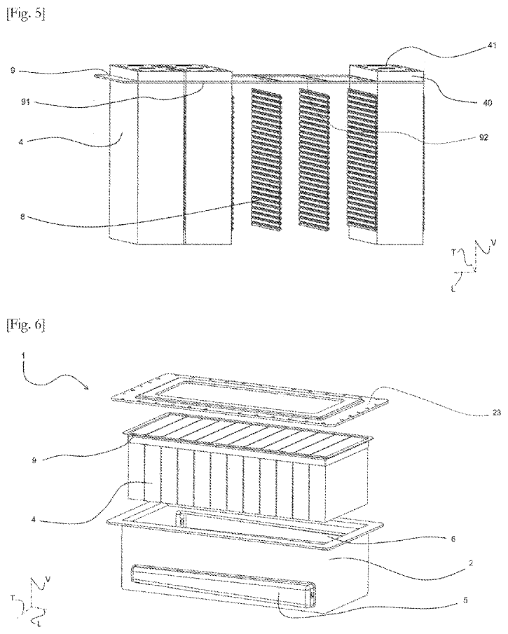

FIG. 5 schematically illustrates another perspective view of part of the sealing element and separating members in FIG. 4, the case also having been removed in this view to show the interaction between these elements and the electrical and/or electronic components;

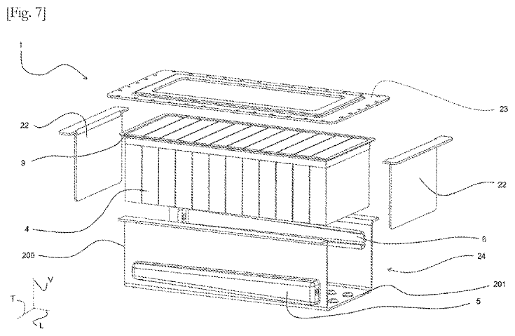

FIG. 6 schematically illustrates an exploded view of the electronic system in FIG. 2;

FIG. 7 schematically illustrates an exploded view of the electronic system in FIG. 2 according to a variant embodiment.

The features, variants and different embodiments of the invention may be combined with one another, in various combinations, provided that they are not mutually incompatible or mutually exclusive. In particular, it is possible to envisage variants of the invention that comprise only a selection of features described below, independently of the other features described, if this selection of features is sufficient to confer a technical advantage and/or to differentiate the invention from the prior art.

In the figures, elements that are common to multiple figures retain the same reference sign.

In the following detailed description, the terms “longitudinal”, “transverse” and “vertical” refer to the orientation of the electronic system according to the invention. A longitudinal direction corresponds to a main direction of elongation of the case of the temperature-regulating device, this longitudinal direction being parallel to a longitudinal axis L of a coordinate system L, V, T illustrated in the figures. A transverse direction corresponds to a direction in which the electrical and/or electronic components mainly extend, this transverse direction being parallel to a transverse axis T of the coordinate system L, V, T, and this transverse axis T being perpendicular to the longitudinal axis L. Finally, a vertical direction corresponds to a direction parallel to a vertical axis V of the coordinate system L, V, T, this vertical axis V being perpendicular to the longitudinal axis L and the transverse axis T.

In addition, in the present description the term “temperature-regulating fluid” can relate to any heat transfer fluid or liquid, advantageously dielectric, two-phase or refrigerant, provided that this fluid or liquid has the effect of regulating the temperature of the electrical and/or electronic components of a temperature-regulating device.

Furthermore, in the following detailed description, the temperature-regulating device according to the invention will be described in relation to an electronic system in the form of a motor vehicle electrical energy storage system, but it should be understood that an application of this type is non-limiting, and that in particular it could be applied in the context of the invention to electrical or electronic components in other electronic systems, and for example computer servers.

FIG. 1 thus schematically illustrates a perspective view of an electronic system 1 according to the invention, in which a temperature-regulating device is configured to modify the temperature, in particular by cooling, of electrical and/or electronic components, which in this case are cells of an electric battery module for a hybrid or electric vehicle.

The electronic system 1 thus comprises both electrical and/or electronic components 4 and a temperature-regulating device. This temperature-regulating device comprises a case 2 extending mainly in a longitudinal direction, between a first longitudinal end 200 of the case 2 and a second longitudinal end 201 of the case 2. The case 2 comprises a bottom wall 21 and four side walls 22 opposite each other in pairs, these walls defining an inner recess 3, configured to accommodate the electrical and/or electronic components 4. Some of these electrical and/or electronic components 4 have been removed from the illustration shown in FIG. 1 in order to allow an improved view of the other components of the electronic system 1.

The electrical and/or electronic components 4 are positioned next to each other along the longitudinal direction of the case 2, and in this case are positioned parallel to each other, perpendicular to the longitudinal direction of the case. At least one of the faces of an electrical and/or electronic component 4 extending in a vertical and transverse plane, perpendicular to the longitudinal direction of the case, is facing one of the faces, extending in a vertical and transverse plane, of a neighboring electrical and/or electronic component 4. Each electrical and/or electronic component 4 is positioned at a distance from the neighboring electrical and/or electronic component 4, and at a distance from the side walls 22 that delimit the inner recess 3 so that they define spaces between them. These spaces in particular allow the temperature-regulating fluid to flow between the electrical and/or electronic components 4 and between the electrical and/or electronic components 4 and the side walls 22, which ensures optimum temperature regulation of each electrical and/or electronic component within the electronic system 1.

The electrical and/or electronic components 4 have, on a vertical end face 40 that extends opposite the bottom wall, connection elements 41 making it possible to connect the electrical and/or electronic components to an electrical supply and/or distribution network of the vehicle.

The side walls 22 of the case 2 have outer faces 220, these outer faces 220 of the side walls 22 being defined as those that are on the opposite side from the inner recess 3.

In order to allow the flow of temperature-regulating fluid within the temperature-regulating device, and the replacement of this temperature-regulating fluid to facilitate the exchange, and in particular, the discharge of heat energy out of the case 2 of the temperature-regulating device, the case 2 comprises at least one temperature-regulating fluid supply element 5 and at least one temperature-regulating fluid discharge element 6, these supply 5 and discharge 6 elements communicating with the inner recess 3. In the example illustrated, without limiting the present invention, the temperature-regulating fluid supply element 5 and the temperature-regulating fluid discharge element 6 respectively protrude from one of the outer faces 220 of the side walls 22 of the case 2.

The electronic system 1 comprises a sealing element 9 that is particular according to the invention in that it is configured to be arranged both between the electrical and/or electronic components 4 and the walls 22 of the case 2, and in each gap formed between two neighboring electrical and/or electronic components 4. It will thus be understood that the sealing element 9, which is integrally formed in one piece, surrounds each electrical and/or electronic component 4 and also surrounds the assembly formed by the juxtaposition of all of the electrical and/or electronic components 4. The sealing element, in various embodiments, will be described in greater detail hereinafter.

The case 2 can further comprise fastening means 210, which in this case consist of extensions of the bottom wall 21 and comprise stiffening ribs connected to the side walls 22 that form the first longitudinal end 200 and the second longitudinal end 201 of the case 2. These fastening means 210, for example fastening tabs provided with eyelets, facilitate the securing of the electronic system 1 to the hybrid or electric vehicle on which it is to be provided.

A first embodiment of an electronic system according to the invention, which includes most of the features described above with reference to FIG. 1, will now be described with reference to FIG. 2.

The case 2 comprises a lid 23, not shown in FIG. 1, which closes the inner recess 3 defined by the side walls 22 and the bottom wall 21. This lid 23 rests on a rim 231 formed by the extension of a vertical end of these side walls 22 opposite the bottom wall. More particularly, a first portion 231A of this rim 231 extends toward the outside of the inner recess 3, extending the corresponding side wall substantially perpendicularly in a substantially transverse direction, and a second portion 231B of this rim 231 extends the first portion 231A opposite the bottom wall 21 substantially perpendicularly in a substantially vertical direction. In the example illustrated, the rim 231 is present continuously over the entire perimeter of the case 2, forming an extension of each of the lateral faces 22.

The lid 23 extends from the first longitudinal end 200 of the case 2 to the second longitudinal end 201 of the case 2, substantially parallel to the bottom wall 21. This lid 23 forms a frame the middle of which is empty, so that it covers only the parts of the electrical and/or electronic components 4 that are in the vicinity of the side walls 22, and thus allows access to the connection elements 41, not shown in FIG. 2, which are positioned on the vertical end face 40 of these electrical and/or electronic components 4. It will thus be understood that the lid 23 has an opening giving access to these connection elements 41 of the electrical and/or electronic components 4 positioned in the inner recess 3, the peripheral region of this inner recess 3 being covered by the lid 23.

The lid 23 can be fastened to a base 24 of the case 2 by means of screws or rivets 230, thus helping to seal the electronic system 1.

The sealing element 9 comprises an edge 91 and transverse ribs 92 that extend across the region delimited by the edge. According to the embodiment shown in FIG. 2, the edge 91 of the sealing element 9 rests on the rim 231, and more particularly on the first portion 231A of this rim extending in a transverse and longitudinal plane. The sealing element 9 is thus in contact with each of the lateral faces 22 of the case 2.

At least on its edge, the sealing element 9 comprises a rigid body and an elastically deformable part overmolded on this rigid body. The presence of the rigid body allows the sealing element to rest stably on the first portion 231A of the rim 231, and the elastically deformable part ensures contact between the sealing element and the walls of the case, here the first portion of the rim, to form the seal.

Still according to the embodiment shown in FIG. 2, the edge 91 of the sealing element 9 is extended by a flank 93 extending substantially perpendicular to the longitudinal and transverse plane in which this edge 91 is mainly contained, the transverse ribs 92 extending from this flank 93.

In this context, the transverse ribs 92 can all extend in a plane parallel to the longitudinal and transverse plane in which the edge 91 is mainly contained, vertically offset with respect to the edge 91 and therefore with respect to the first portion 231A of the rim 231, or they can each extend in a vertical and transverse plane from the flank 93.

In both cases, the transverse ribs 92 form strips of the sealing element 9 that cross the case from one side to the other in a transverse direction. It will thus be understood that the transverse ribs 92 are substantially perpendicular to the longitudinal direction of the case 2.

The transverse ribs 92 are positioned at regular intervals in a longitudinal direction, so that each transverse rib 92 can be arranged in the gaps formed between two neighboring electrical and/or electronic components 4 or, in the vicinity of the longitudinal ends 200 and 201 of the case 2, between an electrical and/or electronic component 4 and a side wall 22.

These transverse ribs 92 are positioned in the vicinity of the vertical end 40 of the electrical and/or electronic components 4, this vertical end 40 being defined as the end thereof that is at a distance from the bottom wall 21.

At least one of the walls defining the inner recess, in this case the bottom wall 21, can comprise holding elements 42 that are configured to hold the electrical and/or electronic components 4 at a distance from each other and at a distance from the walls defining the inner recess 3 of the case 2. By way of example, as illustrated in FIGS. 2 and 3, these holding elements 42 are aligned in two parallel rows, extending from the first longitudinal end 200 of the case 2 to the second longitudinal end 201 of the case 2.

A second embodiment will now be described, with reference to FIGS. 3 to 5 in particular, that differs from the embodiment described above in the arrangement of the supporting region for the sealing element, which is formed in the side walls of the case, and in the shape of the sealing element.

As mentioned above, the side walls 22 of the case 2 have outer faces 220 defined as the faces that are on the opposite side from the inner recess 3, and they have inner faces 221, which are the faces facing this inner recess 3, as can be seen in particular in FIG. 3.

The inner faces 221 of the side walls 22 in this case comprise a shoulder 222, which extends along these inner faces 221 around the entire perimeter of the case 2. This shoulder 222 extends substantially parallel to the bottom wall, toward the outside of the case 2, and contributes to forming an enlargement of the dimension of the inner recess 3 delimited between the side walls 22.

The side walls 22 further have, at the vertical end thereof opposite the bottom wall, a rim 231 formed by a substantially vertical extension of these side walls 22, the rim 231 extending toward the outside of the inner recess 3 in a substantially transverse direction. According to the embodiment shown in FIG. 3, and unlike in the embodiment illustrated in FIG. 2, the rim 231 has only a first portion 231A extending the corresponding side wall substantially perpendicularly in a substantially transverse direction. This rim 231 is present on each of the side faces 22, the first portion 231A perpendicularly extending the shoulder 222.

The inner faces 221 of the side walls 2 that are positioned in the vicinity of the first longitudinal end 200 and the second longitudinal end 201 of the case 2, in other words the inner faces 221 of the side walls 2 that do not bear the temperature-regulating liquid supply element 5 and the temperature-regulating liquid discharge element 6, have notches 223.

The notches 223 have a longitudinal end 224, which originates at the shoulder 222 of the inner faces 221 of the side walls 22 of the case 2 defining the inner recess 3. These notches 223 are formed by a local deformation of the side wall 22 that creates a protrusion on the outer face 220. An embodiment could however be envisaged with a flat outer face 220 and a notch 223 made in the material of the corresponding side wall 22.

These notches 223 extend from the shoulder 222, in a substantially vertical direction, toward but not as far as the bottom wall 21. The notches 223 thus have a vertical end 224, opposite the shoulder 222, that extends at a distance from the bottom wall 21.

The notches 223 are capable of receiving elastic return means, for example springs, intended to hold the electrical and/or electronic components 4 with respect to each other, by exerting an elastic return force substantially perpendicular to the main plane of elongation of each of the electrical and/or electronic components 4.

It should be noted that such notches and such associated elastic return means can be present in the electronic system configured according to the first embodiment and in particular illustrated in FIG. 2.

FIGS. 4 and 5 more particularly show the particular form of the sealing element as it is used in the second embodiment, it being understood that in this particular form, the sealing element could be implemented with other case configurations. In these figures, the case 2 has been removed in order to show the components located inside it.

The sealing element 9 is again configured so that it is arranged between the electrical and/or electronic components 4 and the side walls 22. This sealing element 9 is positioned in the vicinity of the vertical end 40 of the electrical and/or electronic components 4 and has an edge 91 and transverse ribs 92.

According to the embodiment shown in FIGS. 4 and 5, and unlike in the embodiment in FIG. 2, the edge 91 of the sealing element 9 and the transverse ribs 92 extend mainly in the same plane. It will thus be understood that the sealing element 9 is in this case a substantially flat element.

According to this embodiment, the edge 91 rests on the shoulder 222 as illustrated in FIG. 3, this shoulder 222 being formed by the side walls 22 inside the inner recess 3. The edge 91 therefore follows the shape of the inner recess 3.

The edge 91 extends mainly in a longitudinal and transverse plane, the transverse ribs 92 extending across the case 2 substantially in this same plane, in a transverse direction.

As has been described above, the transverse ribs 92 are positioned equidistant from each other, and are configured so that they can be interposed between each electrical and/or electronic component 4, thus sealing the vertical end 40 of each electrical and/or electronic component 4. This particular positioning of the sealing element 9 prevents the immersion of the connection elements 41 of the electrical and/or electronic components 4 in the temperature-regulating fluid, these connection elements 41 being arranged on the vertical end 40 of the electrical and/or electronic components 4.

The other features of the sealing element described with reference to FIG. 2 apply mutatis mutandis to the embodiment shown in FIGS. 3 to 5, provided that they are not incompatible with it.

Furthermore, the electrical and/or electronic components 4 are in this case separated from at least one neighboring electrical and/or electronic component by a separating member 8. Each separating member 8 therefore extends within the inner recess from one end of the case 2 to the other in a substantially transverse direction, that is, substantially perpendicular to the direction of elongation of the case 2.

The separating member 8 forms a spacer, which ensures a defined distance between two neighboring electrical and/or electronic components 4. This separating member 8 can be interposed between each electrical and/or electronic component 4 or placed every two electrical and/or electronic components 4, so that each electrical and/or electronic component 4 is separated from at least one other electrical and/or electronic component 4 by a separating member 8.

The separating member 8 can in particular be a corrugated sheet that defines channels for the passage of fluid along each of the electrical and/or electronic components 4 positioned on either side of this separating member 8. It will thus be understood that the separating member 8 is configured to let through the temperature-regulating fluid. The corrugations of the sheet of the separating member are arranged so that they allow and guide the flow of the temperature-regulating fluid from one side wall to the other.

According to a preferred embodiment of the invention, the electrical and/or electronic components 4 are separated by a distance of between 0.2 and 1 mm by the separating member 8.

FIG. 6 illustrates the electronic system 1 in FIG. 2 in a perspective view. According to the embodiment shown in this figure, the case 2 comprises a base 24 and a lid 23 as mentioned above, this base consisting of the bottom wall 21 and the side walls 22. This base forms an integrally formed one-piece assembly. It is not therefore possible to separate the bottom wall 21 from the side walls 22 without damaging one or other of these elements. The one-piece assembly can in particular be obtained by additive manufacturing, and more particularly by 3D printing. In his context, the case 2 can be made from a material selected for its thermal insulation properties. This material selected for its thermal insulation properties can particularly be a plastic material. Even more particularly, this plastic material can be organosheet.

FIG. 7 shows an alternative embodiment that differs from the embodiment described above in that the base 24 does not form a one-piece assembly. In this case, the base 24 is made up of a first element comprising the bottom wall 21 and two opposite side walls 22, while the other two side walls 22 are made separately and then added and fastened to the first element. It will be understood that the base 24 can thus consist of the bottom wall 21 and the opposite side walls 22 that bear the temperature-regulating liquid supply element 5 and the temperature-regulating liquid discharge element 6, the other two side walls 22 being added to the first element of the base 24.

At least the bottom wall 21 and the side walls 22 bearing the temperature-regulating liquid supply element 5 and the temperature-regulating liquid discharge element 6 can be made from metal. Advantageously, this metal can be aluminum.

In this context, the first element of the base 24 can for example be formed by pressing, which simplifies the formation of the U-shaped section of each of the ducts 50, 60, and then the other side walls 22 are fastened by brazing to the first element of the base 24.

An electronic system 1 according to the invention can be obtained by a method comprising a step of positioning an assembly comprising at least the electrical and/or electronic components 4 in the recess defined by the bottom wall and the side walls of the case, and a step during which the sealing element 9 is arranged both between the electrical and/or electronic components 4 and the walls 22 of the case 2, and in each gap formed between two neighboring electrical and/or electronic components 4. Such a method can apply equally to the embodiment in FIG. 6, according to which the base 24 forms a one-piece assembly, and to the embodiment in FIG. 7, according to which the base 24 is made up of a first element comprising the bottom wall 21 and two opposite side walls 22, the other two side walls 22 being added to this first element.

The positioning step consists of positioning an assembly comprising at least the electrical and/or electronic components 4 within the inner recess 3 of the case 2. This step can in particular involve the holding elements 42, which are capable of being interposed between each electrical and/or electronic component 4 in order to ensure optimum positioning of the electrical and/or electronic components 4 within the inner recess 3. The assembly comprising at least the electrical and/or electronic components 4 can further comprise at least one separating member 8 positioned between two neighboring electrical and/or electronic components. This separating member 8 can be positioned between two adjacent electrical and/or electronic components 4, or every two electrical and/or electronic components 4, so that each electrical and/or electronic component 4 is separated from at least one other electrical and/or electronic component 4 by this separating member 8.

The method for obtaining an electronic system according to the invention continues with a step during which the sealing element 9 is arranged both between the electrical and/or electronic components 4 and the walls 22 of the case 2, and in each gap formed between two neighboring electrical and/or electronic components 4. It will be understood that the edge 91 of the sealing element 9 is arranged between the electrical and/or electronic components 4 and the side walls 22 of the case, while the transverse ribs 92 of this sealing element are interposed between each electrical and/or electronic component 4, in the gaps separating them. This edge 91 rests on a supporting surface formed, depending on the embodiment, by the shoulder 221 formed in the faces of the walls 22 or by the first portion 231A of the rim 231 of these walls 22, and rests stably on this supporting surface due to its rigid body. Once the sealing element 9 is in position, the case 2 can be closed by the lid 23. This lid 23 can be fastened to the rim 231, for example by means of screws or rivets 230, in order to seal the case 2.

The method can further comprise a step of holding the assembly comprising at least the electrical and/or electronic components 4 in position, between the positioning step and the step in which the sealing element 9 is arranged. This holding step can in particular consist of positioning elastic return means as described above between two opposite side walls 22 and the assembly formed by at least the electrical and/or electronic components 4. Such elastic return means, such as springs, can be positioned in the notches 223 in the inner faces 221 of the side walls 22, in order to hold the electrical and/or electronic components 4 in place.

The present invention thus proposes an electronic system comprising electrical and/or electronic components and a temperature-regulating device, this electronic system having a sealing element capable of preventing the flow of the temperature-regulating fluid in the vicinity of the end of the electrical and/or electronic components that bears their connection elements. Such an electronic system is also easier to mount, as the sealing assembly is integrally formed. In a single mounting operation, it is thus possible to fill all of the spaces or gaps through which the temperature-regulating fluid might escape.

However, the present invention is not limited to the means and configurations described and illustrated here, and also extends to any equivalent means and configurations, as well as to any technically operational combination of such means, provided that it comprises a sealing element configured to be arranged, in one piece, both between the electrical and/or electronic components and the walls of the case, and between two neighboring electrical and/or electronic components.

1. An electronic system comprising:
electrical and/or electronic components;
a temperature-regulating device comprising a case,
wherein the case is configured to accommodate the electrical and/or electronic components,
wherein the case comprises a bottom wall and side walls opposite each other in pairs defining an inner recess capable of receiving the electrical and/or electronic components positioned side-by-side in a longitudinal direction of the case,
wherein the case further comprises at least one temperature-regulating fluid supply element and at least one temperature-regulating fluid discharge element; and
a sealing element, configured to be arranged both between the electrical and/or electronic components and the walls of the case, and in each gap formed between two neighboring electrical and/or electronic components.

2. The electronic system as claimed in claim 1,
wherein the sealing element comprises:
an edge following the shape of the faces of the walls of the case defining the inner recess, and
transverse ribs positioned equidistant from each other,
wherein the transverse ribs are substantially perpendicular to the longitudinal direction of the case,
wherein the edge of the sealing element and the transverse ribs extend mainly in the same plane.

3. The electronic system as claimed in claim 2,
wherein the edge of the sealing element is extended by a flank extending substantially perpendicular to this edge, wherein the transverse ribs extend from the flank.

4. The electronic system as claimed in claim 1,
wherein the sealing element comprises a rigid body and an elastically deformable part overmolded on the rigid body.

5. The electronic system as claimed in claim 1,
wherein the sealing element rests on a shoulder formed in the faces of the walls of the case defining the inner recess,
wherein the shoulder being is present on each of the faces.

6. The electronic system as claimed in claim 4,
wherein the sealing element rests on a shoulder formed in the faces of the walls of the case defining the inner recess,
wherein the shoulder is present on each of the faces, and
wherein the sealing element rests on the shoulder via the rigid body of the sealing element.

7. The electronic system as claimed in claim 1,
wherein the faces of the walls of the case defining the inner recess that are perpendicular to the longitudinal direction of the case comprise notches,
wherein the notches extend from a vertical end edge of the walls,
wherein the notches are opposite the bottom wall, and substantially perpendicular to the bottom wall.

8. The electronic system as claimed in claim 7,
wherein the notches comprise a longitudinal end originating at the shoulder of the faces of the walls of the case defining the inner recess.

9. The electronic system as claimed in claim 1,
wherein the case comprises a base and a lid,
wherein the base comprises the bottom wall and the side walls,
wherein the base is formed by a first element comprising the bottom wall and two opposite side walls, with the addition of the other two side walls.

10. A method for obtaining an electronic system as claimed in claim 1, the method comprising:
positioning an assembly comprising at least the electrical and/or electronic components in the inner recess defined by the bottom wall and the side walls of the case; and
arranging the sealing element both between the electrical and/or electronic components and the walls of the case, and in each gap formed between two neighboring electrical and/or electronic components.
